(19) United States
(12) Patent Application Publication
(10) Pub. No.: US 2007/0014970 A1
(43) Pub. Date: Jan. 18, 2007

(54) Dispersion of water in hydrophobic oxides for producing hydrophobic nanostructured surfaces

(76) Inventors: Edwin Nun, Billerbeck (DE); Markus Oles, Hattingen (DE)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 10/546,979

(22) PCT Filed: Dec. 9, 2003
(86) PCT No.: PCT/EP03/50970

§ 371 Date: Jun. 12, 2006

(30) Foreign Application Priority Data
Feb. 27, 2003 (DE) 10308379.0

(51) Int. Cl. G11B 5/64

(52) U.S. Cl. 428/141

(57) ABSTRACT

The invention relates to a process for producing hydrophobic nanostructured surfaces, which features the application of a dispersion of water in hydrophobic oxides to the surface to be treated and the subsequent removal of the water, and also to the surfaces produced by means of this process and to their use for producing soil- and water-repellent surfaces on objects.

The invention relates to a process for producing hydrophobic nanostructured surfaces, and also to the surfaces produced by means of this process and to their use for producing soil- and water-repellent surfaces on objects.

Conventional surfaces are generally wetted by liquids. The degree of wetting is an interplay between the cohesive forces in the liquid and the adhesive forces between the surface and the liquid.

In many cases, wetting of the surface by a liquid is undesired. For example, the wetting of a surface with water leads to the formation of water droplets which adhere to the surface. Ingredients dissolved in the water or suspended solids remain on the surface as undesired residues when the water evaporates. This problem exists in particular in the case of surfaces which are exposed to rainwater or process water.

It is already known that the wettability of a surface for hydrophilic liquids is reduced by hydrophobic finishing of the surface. In this context, useful coating materials are in particular polysiloxanes, perfluorinated polymers or fluorinated copolymers, in particular the highly hydrophobic polytetrafluoroethylene (PTFE). The finishing of the surface with one of these compounds lowers the adhesive forces between the surface and the liquid. What generally forms is a drop with a relatively high contact angle and improved slide-off or even roll-off behavior. No self-cleaning of such surfaces can be observed.

It has additionally been found to be favorable to structure hydrophobic surfaces. As early as 1947, an application was filed for a Swiss patent with the number 268 258 and the title “Water-repellent coatings”. This patent claims a water-repellent coating having a contact angle with respect to water of more than 120°, which features a fine-grain surface and comprises fine powders which have been rendered water-repellent by an organosilicon derivative and adhere firmly to their substrate. The fine powders claimed here are silicic anhydride, talc, kaolin or smectic clays.

In “Khimia i Zhizu (Chemistry and Life) 11 (1982), 38 ff.”, A. A. Abramson also describes surfaces which have a very high contact angle. A connection to self-cleaning of these surfaces is not mentioned. A process to produce such surfaces is stated in this document to be unknown.

The connection between self-cleaning and structure of a surface is known as the lotus effect and was described for the first time by W. Barthlott and C. Neinhuis in “Biologie in unserer Zeit 28 (1998) 314-322”.

For example, WO 96/04123 also describes self-cleaning surfaces of objects which have a synthetic surface structure which has elevations and hollows, the structure being characterized in particular by the distance between elevations and hollows and the height of the elevations. The surfaces are produced, for example, by applying Teflon powder to a surface treated with adhesive. In addition, the embossing of a structure into a thermoplastically reshapeable hydrophobic material is mentioned.

U.S. Pat. No. 3,354,022 discloses analogous surfaces. Here too, the production is effected either by embossing the structure or by applying hydrophobic particles; for example, wax particles are mentioned. Additionally described is a surface which comprises glass dust in a wax matrix. However, surfaces of this type are mechanically very labile.

JP 7328532 A discloses a coating process in which fine particles having a hydrophobic surface are applied to a moist coating which is subsequently cured. This affords water-repellent surfaces.

DE 100 22 246 A1 describes a process in which hydrophobic nanostructured particles find use together with an adhesive or adhesive-like component in spray form. By means of this process, structured surfaces are obtained but they do not have lasting stability.

The disadvantage of the aforementioned processes and surfaces is that very labile surfaces which are not mechanically stressable are produced, that fine-dusting nanostructured powders are used or that organic solvents have to be present.

It is therefore an object of the present invention to provide a process for producing hydrophobic nanostructured surfaces, in which organic solvents and fine-dusting powders should be dispensed with.

It has been found that, surprisingly, hydrophobic nanostructured surfaces can be produced by applying a dispersion of water in hydrophobic oxides to the surface to be treated and subsequently removing the water. Dispersions of water in hydrophobic oxides in the form of hydrophobic pyrogenic silica have already been known for some time. These dispersions do not dust and are very readily free-flowing and thus easy to meter. The achievement of the object was all the more surprising because it was found that this dispersion, used in the process according to the invention, can give rise to hydrophobic nanostructured surfaces which have soil- and water-repellent properties.

The present invention provides a process for producing hydrophobic nanostructured surfaces, in which a dispersion of water in hydrophobic oxides is applied to the surface to be treated and the water is subsequently removed.

The invention likewise provides surfaces which have been produced by the process according to the invention, and for the use of the process for producing soil- and water-repellent surfaces.

The present invention has the advantage that the dispersion of water in hydrophobic oxides used here neither dusts nor is difficult to meter. On the contrary, this dispersion is very readily free-flowing. Compared to a spray, as described, for example, in DE 100 22 246 A1, the dispersion used has the advantage of the absence of organic solvents. Technical protective devices, for example post-combustion of the solvent vapors owing to the immission of organic solvents, are not necessary in the process according to the invention. A further advantage of the process according to the invention is its freedom from dust. In the application of hydrophobic powders which have a large surface area and some degree of porosity, a high level of dust pollution has to be expected in the immediate environment. In order to be able to comply with the maximum workplace concentration values, expensive special apparatus, for example a dedusting plant operated at high voltage or an ultrafine dust filter plant, has to be installed and operated. However, such special apparatus is not necessary in the process according to the invention. In addition, the use of a dispersion of water in hydrophobic oxides allows the metering precision to be distinctly increased over the prior art processes.

The process according to the invention for producing hydrophobic nanostructured surfaces comprises applying a dispersion of water in hydrophobic oxides to the surface to be treated and subsequently removing the water from this dispersion.

The dispersion of water in hydrophobic oxides used in the process according to the invention preferably has from 50.1% by weight to 99.5% by weight of water, preferably from 60% by weight to 99% by weight and more preferably from 80% by weight to 98% by weight.

The dispersion used in the process according to the invention comprises hydrophobic oxides which preferably have a surface with an irregular fine structure in the nanometer range, i.e. in the range from 1 nm to 1000 nm, preferably from 5 nm to 750 nm and most preferably from 10 nm to 100 nm. Fine structure refers to structures which have elevations, peaks, crevices, ridges, fissures, undercuts, notches and/or holes within the above-specified separations and ranges. The fine structure of these hydrophobic oxides may preferably have elevations with an aspect ratio of greater than 1, more preferably greater than 1.5. The aspect ratio is in turn defined as the quotient of maximum height to maximum width of the elevation; in the case of ridges or other longitudinal elevations, the width at right angles to longitudinal direction is employed.

In the process according to the invention, preference is given to using dispersions which comprise hydrophobic oxides which have an average particle diameter of from 0.005 μm to 100 μm, preferably from 0.01 μm to 50 μm and more preferably from 0.01 μm to 30 μm. For instance, it is also possible to use hydrophobic oxides which are formed from primary particles to give agglomerates or aggregates having a size of from 0.02 μm to 100 μm.

The dispersion used in the process according to the invention may comprise oxides which have been hydrophobized in a manner known to those skilled in the art (Pigments Technical Bulletin 18, of Degussa AG). This is effected preferably by treatment with at least one compound selected from the group of the alkylsilanes, silicones, silicone oils, alkyldisilazanes, for example with hexamethyldisilazane, or perfluoroalkylsilanes.

In the process according to the invention, a dispersion is used which comprises, as the hydrophobic oxide, preferably hydrophobic pyrogenic oxide particles consisting of a material selected from silica, alumina, zirconia or titania, or hydrophobically precipitated oxide particles selected from silica, alumina, zirconia or titania, preferably hydrophobic precipitated silicas. In the process according to the invention, particular preference is given to using a dispersion which comprises hydrophobic pyrogenic silicas. In a particular embodiment of the process according to the invention, the dispersion comprises a mixture of hydrophobic oxide particles. However, it is also possible to use hydrophobic mixed oxides. In a particularly preferred embodiment of the process according to the invention, hydrophobic Aerosils®, preferably Aerosil® VPR 411, Aerosil® R812, Aerosil® R805, Aerosil® R972, Aerosil® R974 or Aerosil® R 8200, more preferably Aerosil® VP LE 8241, are used in the dispersion.

The dispersion used in the process according to the invention is prepared by a process as described in Pigments Technical Bulletin, Basic Characteristics of Aerosil, No. 11 of Degussa AG. In this process, hydrophobic Aerosil®, which normally floats on water and is not wetted by water, is used. The dispersion of water in hydrophobic pyrogenic silica is prepared by the introduction of high mechanical energy. In the course of this, the water droplets are surrounded by a hydrophobic Aerosil® and thus protected from coalescence. These dispersions comprise predominantly water and only small amounts of hydrophobic pyrogenic silica. In addition, in 1964 the Deutsche Gold- and Silber-Scheideanstalt described a process for incorporating water into ultrafinely distributed silica in the German patent DE 1 467 023 C. These dispersions are also referred to as “dry water”. In a formal sense, they are a special form of the dispersion of a hydrophobic silica in air modified by water droplets. A light micrograph in Technical Bulletin Pigments, Basic Characteristics of Aerosil, No. 11 shows such a dispersion of water in Aerosil® R812 with an Aerosil® fraction of 3% by weight. In this dispersion, the surrounded water droplets have a particle size of <100 μm.

In a first process step of the process according to the invention, the dispersion is applied to the surface to be treated. In a preferred embodiment of the process according to the invention, the dispersion is applied to the surface of a textile fabric. By means of the process according to the invention, surfaces of textiles may preferably be treated, more preferably surfaces of textiles of the clothing industry, carpets, domestic textiles, nonwovens and textile structures which serve technical purposes.

In a particular embodiment of the process according to the invention, surfaces having an arithmetic mean of roughness value Ra, determined to DIN 4762, of >1 μm may be modified.

In a further embodiment of the process according to the invention, the dispersion may also be applied to the surface of a polymer film. When the dispersion is applied to a polymer film, this is preferably done after the extrusion, so that the polymer film has not yet solidified. Preference is given to applying the dispersion to a heated polymer film.

The polymer films themselves may comprise, as the material, preferably polymers based on polycarbonates, polyoxymethylenes, poly(meth)acrylates, polyamides, polyvinyl chloride (PVC), polyethylenes, polypropylenes, polystyrenes, polyesters, aliphatic linear or branched polyalkenes, cyclic polyalkenes, polyacrylonitrile or polyalkylene terephthalates, and also mixtures thereof or copolymers thereof. More preferably, the polymer films comprise a material selected from poly(vinylidene fluoride), poly(hexafluoropropylene), poly(perfluoropropylene oxide), poly(fluoroalkyl acrylate), poly(fluoroalkyl methacrylate), poly(vinyl perfluoroalkyl ether) or other homo- or copolymers of perfluoroalkoxy compounds, poly(ethylene), poly(propylene), poly(isobutene), poly(4-methyl-1-pentene) or polynorbonene. Most preferably, the polymer films comprise, as a material for the surface, poly(ethylene), poly(propylene), polycarbonate, polyesters or poly(vinylidene fluoride). In addition to the polymers, the materials may comprise the customary additives and assistants, for example plasticizers, pigments or fillers.

In a preferred embodiment, the surface to be treated is sprinkled with the dispersion of water in hydrophobic oxides. The dispersion may be applied to the surface to be treated by means of various processes; it is important in this context that the dispersion in the form of many small particles moves downward toward the surface to be treated only by means of gravitational force. Preference is given to distributing the dispersion by means of a gas impulse, in particular by means of an inert gas impulse, but more preferably by means of a nitrogen impulse, in an atomization chamber above the surface to be treated. In this way, fine distribution of the dispersion on the surface to be treated can be enabled. In addition to the distribution of the dispersion in the atomization chamber by means of a gas impulse, further mechanical methods of fine distribution of a dispersion on the surface to be treated can be employed; for example, the dispersion can be distributed by means of a brush wiper.

In an optional process step, the surface may be treated mechanically after the application of the dispersion in order to enable deeper penetration of the dispersion of water in hydrophobic oxides into the surface structure. In a preferred embodiment of the process according to the invention, the surface is brushed for this purpose after the application of the dispersion. In addition, the surface may be subjected to vibrations and/or shaking motions after the application of the dispersion.

In a further embodiment of the process according to the invention, the surface is subjected to a mechanical pressure, for example by means of presses or rolls, after the application of the dispersion. This type of mechanical treatment is suitable in the process according to the invention preferentially for polymer films to whose surface the dispersion has been applied. It is advantageous in this context when the surface of the polymer film has not already solidified.

In a final process step of the process according to the invention, the water is removed. This can be done preferably by means of electromagnetic radiation, preferably by means of thermal energy, for example by means of hot air or infrared radiation. In a particularly preferred embodiment of the process according to the invention, the water is removed by means of microwave energy. The water may likewise be removed by means of application of a vacuum. In a particular embodiment of this process step of the process according to the invention, the dispersion is separated into water and hydrophobic oxide by means of mechanical pressure, for example by means of presses or rolls. The separation into water and particles has the effect that the hydrophobic oxide particles which have hitherto stabilized the water phase in the dispersion can come to rest deeper into the surface structure and their hydrophobic properties become active there. Introduced so deeply into the surface structure, these surfaces are virtually nondusting. By virtue of the fact that only water has to be removed, none of the disadvantages which occur as a result of application of dusts or dispersions in solvents are present.

This invention further provides surfaces which have been produced by means of the process according to the invention. The inventive surfaces preferably have soil- and water-repellent properties.

On or with in their surface, these inventive surfaces comprise hydrophobic oxides. The inventive surfaces more preferably comprise hydrophobic oxides which have an average particle diameter of from 0.005 μm to 100 μm, more preferably from 0.01 μm to 50 μm and most preferably from 0.01 μm to 30 μm.

It may be advantageous when the hydrophobic oxides of the inventive surfaces have a structured surface. These hydrophobic oxides preferably have an irregular fine structure in the nanometer range, i.e. in the range from 1 nm to 1000 nm, preferably from 5 nm to 750 nm most preferably from 10 nm to 100 nm, on the surface. Fine structure refers to structures which have elevations, peaks, crevices, ridges, fissures, undercuts, notches and/or holes within the separations and ranges specified.

The inventive surfaces may comprise hydrophobic oxides which have hydrophobic properties after a suitable treatment, for example silica particles treated with at least one compound from the group of the alkylsilanes, the silicones, the silicone oils, the fluoroalkylsilanes and/or the disilazanes.

As the hydrophobic oxide, the inventive surface preferably comprises hydrophobic pyrogenic oxide particles consisting of a material selected from silica, alumina, zirconia or titania, or hydrophobic precipitated oxide particles selected from silica, alumina, zirconia or titania, preferably hydrophobic precipitated silicas. The inventive surface preferably comprises hydrophobic pyrogenic silicas. In a particular embodiment of the inventive surfaces, they comprise a mixture of hydrophobic oxide particles. However, they may also comprise hydrophobic mixed oxides. In a particularly preferred embodiment of the inventive surfaces, they comprise hydrophobic Aerosil®, preferably Aerosil® VPR 411, Aerosil® R812, Aerosil® R805, Aerosil® R972, Aerosil® R974 or Aerosil® R 8200, more preferably Aerosil® VP LE 8241.

The inventive surfaces preferably have a layer with elevations which are formed by the particles themselves and have a mean height of from 0.02 to 25 μm and a maximum separation of 25 μm, preferably have a mean height of from 0.05 to 10 μm and/or a maximum separation of 10 μm and most preferably have a mean height of from 0.03 to 4 μm and/or a maximum separation of 4 μm. Most preferably, the inventive surfaces have elevations having a height of from 0.05 to 1 μm and a maximum separation of 1 μm. In the context of the present invention, the distance between the elevations is understood to mean the distance between the highest elevation of an elevation of a particle to the next highest elevation of another directly adjacent particle. When an elevation has the shape of a cone, the peak of the cone is the highest elevation of the elevation. When the elevation is a cuboid, the uppermost surface of the cuboid is the highest elevation of the elevation.

The wetting of solids and thus the property of self-cleaning can be described by the contact angle that a water droplet forms with the surface. A contact angle of 0° means full wetting of the surface. The static contact angle is measured generally by means of instruments in which the contact angle is measured visually. On smooth hydrophobic surfaces, static contact angles of less than 125° are typically measured. The present inventive surfaces with self-cleaning properties have static contact angles of preferably greater than 130°, preferably greater than 140° and most preferably greater than 145°. It has also been found that a surface has particularly good self-cleaning properties when it has a difference between advancing and receding angle of not more than 10° C., so that the inventive surfaces preferably have a difference between advancing and receding angle of less than 10°, preferably less than 7° and most preferably less than 6°. For the determination of the advancing angle, a water droplet is placed on the surface by means of a cannula and the droplet on the surface is enlarged by adding water. During the enlargement, the edge of the droplet slides over the surface and the contact angle is determined. The receding angle is measured on the same droplet, except that water is removed through the cannula from the droplet and the contact angle is measured during the reduction of the drop. The difference between the two angles is referred to as hysteresis. The smaller the difference, the smaller the interaction of the water droplet with the surface of the substrate and the better the self-cleaning effect.

The inventive surfaces with self-cleaning properties preferably have an aspect ratio of the elevations which are formed by the hydrophobic oxides themselves of greater than 0.15. The elevations which are formed by the particles themselves preferably have an aspect ratio of greater than 0.3, more preferably of greater than 0.5. The aspect ratio is defined as the quotient of maximum height to maximum width of the structure of the elevations.

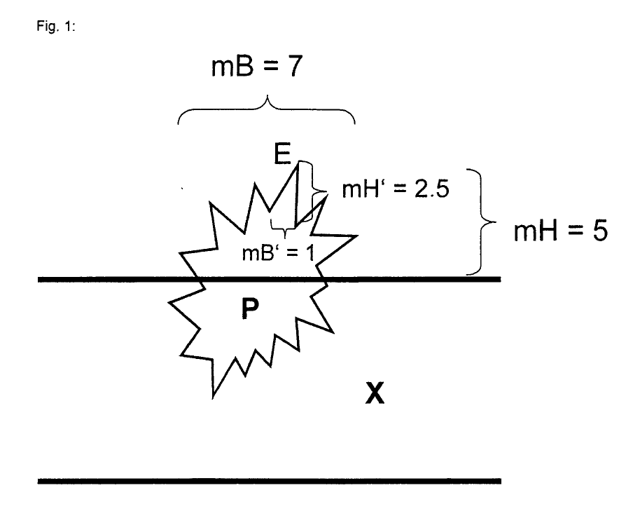

Particularly preferred inventive surfaces comprise hydrophobic oxides having an irregular, aerially fissured fine structure which preferably has elevations having an aspect ratio in the fine structures of greater than 1, more preferably greater than 1.5. The aspect ratio is in turn defined as the quotient of the maximum height to maximum width of the elevation. FIG. 1 schematically illustrates the difference between the elevations which are formed by the particles and the elevations which are formed by the fine structure. The figure FIG. 1 shows the surface of a surface-modified object X which comprises a particle P (for simplification of the illustration, only one particle is depicted). The elevation which is formed by the particle itself has an aspect ratio of approx. 0.71, calculated as the quotient of the maximum height of the particle mH which is 5, since only some of the particle which protrudes from the surface X makes a contribution to the elevation, and the maximum width mB which is 7 relative thereto. A selected elevation E of the elevations which are present on the particles by virtue of the fine structure of the particles has an aspect ratio of 2.5, calculated as the quotient of the maximum height of the elevation mH′ which is 2.5, and the maximum width mB′ which is 1 relative thereto.

The invention likewise provides for the use of the process according to the invention for producing soil- and water-repellent surfaces, preferably for producing soil- and water-repellent surfaces of textile fabrics.

The process according to the invention may be used more preferably for producing soil- and water-repellent surfaces of clothing, in particular for the production of protective clothing, rain clothing and safety clothing with signal effect, industrial textiles, in particular for production of covering tarpaulins, tent tarpaulins, protective tarpaulins, truck tarpaulins, fabrics for textile construction, in particular for the production of sunshade roofs, for example marquees, awnings, sunshades, nonwovens and carpets.

The process according to the invention may likewise be used to produce soil- and water-repellent surfaces of films, for example of shrink films or packaging films.

The examples which follow are intended to further illustrate the process according to the invention without any intention that the invention be restricted to this embodiment.

1. Modification of the Surface of a Nonwoven

The modifications (experiment No. 1 and No. 2) were undertaken in an atomization chamber. For these experiments, samples (approx. 30 cm²) of an Evolon® polyethylene terephthalate nonwoven from Freudenberg Evolon KG were placed on the baseplate of an atomization chamber. 2 g of dispersion of water in Aerosil® R812 hydrophobic pyrogenic silica (prepared by the process described in Technical Bulletin Pigments, Basic Characteristics of Aerosil, No. 11 of Degussa; 55% by weight of water, determined gravimetrically) were atomized above the nonwoven by means of a 75 ms-long nitrogen impulse. The free-flowing dispersion was sprinkled in finely divided form onto the surface of the nonwoven.

| Process step | Comparative example | Example No. 1 | Example No. 2 |
|---|---|---|---|
| Atomization | — | ✓ | ✓ |
| Mechanical | — | ✓ | — |
| treatment | | | |
| Thermal | — | ✓ | ✓ |
| treatment | | | |

In example No. 1, the surface of the nonwoven was treated by circular brushing by means of a disk brush after the application of the dispersion, thus moving the dispension into deeper layers. In example No. 2, this step of the process was dispensed with.

The treated nonwovens were subsequently dried at 130° C. and a residence time of 10 min in a hot-air oven.

2. Characterization of the Treated Surfaces

2.1 Description and Performance of the Characterization.

The characterization is divided into:

2.1.1 The Roll-Off Behavior of a Water Droplet on an Inclined Surface.

A droplet of demineralized water is placed by means of a Pasteur pipette onto a sample having an angle of inclination of 45°, and the behavior of the droplet is subsequently assessed as follows. The roll-off behavior is observed at four points on the sample.

| Observation | Assessment |
|---|---|
| The drop does not roll off or the drop | − |
| slides slowly downward in a stretched | |
| droplet form. | |
| The droplet rolls off rapidly in the | + |
| droplet form of a sphere without wetting. | |
| The sample exhibits nonuniform droplet | +/− |
| behavior. | |

2.1.2 Wetting Behavior of a Droplet Resting on the Sample for 5 Seconds.

When a droplet of demineralized water resides for five seconds on a sample having the angle of inclination of 0°, nonoptimal roughness and/or nonoptimal hydrophobicity results in wetting of the surface of this sample. The sample is placed onto a surface having an angle of inclination of 0° C. and some droplets of demineralized water are subsequently placed on with a Pasteur pipette. The droplets reside for 5 seconds on the surface of the sample. Subsequently, the sample is tilted up to not more than 60°. The behavior of the water droplets is assessed as follows:

| Observation | Assessment |
|---|---|
| The droplet or a water residue still | − |
| adheres to the surface. | |
| Droplet rolls off rapidly in the droplet | + |
| form of a sphere without wetting. | |
| The sample exhibits nonuniform droplet | +/− |
| behavior. | |

2.1.3 Wetting Behavior of a Falling Droplet

The kinetic energy with which a water droplet hits the sample can reveal a further possible weakness. Here too, nonoptimal roughness or hydrophobicity can result in wetting of the surface. When a droplet of demineralized water hits a sample which does not have optimal roughness and/or hydrophobicity, the surface is wetted by the water droplet.

The sample is placed on a surface having the angle of inclination of 0° C., then drops of demineralized water are allowed to fall from a height of 50 cm onto the sample using a Pasteur pipette. The behavior of the water droplets on the sample is assessed as follows:

| Observation | Assessment |
|---|---|
| The sample is wetted by the water droplet. | − |
| The sample is not wetted by the water | + |
| droplet. | |
| The sample exhibits nonuniform droplet | +/− |
| behavior. | |

2.2 Results of the Characterization According to 2.1.1 to 2.1.3.

The table which follows shows a comparison of the results from the characterization of the samples according to 2.1.1 to 2.1.3 which have been produced according to 1.

| | Roll-off | Wetting | Wetting |
|---|---|---|---|
| | behavior | behavior | behavior |
| | according to | according to | according to |
| | 2.1.1 | 2.1.2 | 2.1.3 |
| Comparative | +/− | +/− | − |
| example | | | |
| No. 1 | + | + | + |
| No. 2 | + | + | +/− |

2.3 Determination of the Roll-Off Angle

The roll-off angle specifies the smallest angle of inclination at which a defined droplet of demineralized water begins to roll off the sample surface to be characterized. A droplet of demineralized water is placed by means of a pipette onto a sample having an angle of inclination of 0° C., and the angle of inclination is subsequently increased slowly and continuously. As soon as the droplet begins to roll off, the angle of inclination established is recorded. This measurement is carried out at four different points on the sample. A range of the angle of inclination of 0°-55° is measured. The determination of the roll-off angle was carried out at a room temperature of 21.5° C. and a water droplet temperature of 20.5° C. The water droplet size was 20 or 60 μl.

| | Roll-off angle | Roll-off angle |
|---|---|---|
| | (at a droplet | (at a droplet |
| | size of 60 μl) | size of 20 μl) |
| Comparative example | 33.3 | 60 |
| No. 1 | 3.2 | 7.9 |
| No. 2 | 10.8 | 39.1 |

2.4 Scanning Electron Micrographs

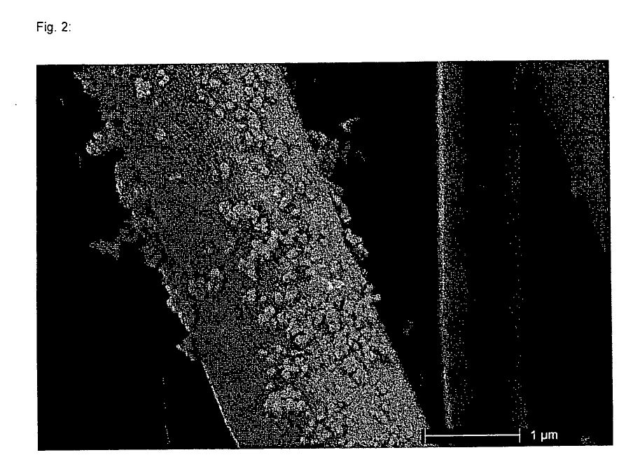

The scanning electron micrograph FIG. 2 shows a nonwoven surface treated according to example No. 1.

These tables demonstrate that a hydrophobic self-cleaning surface can be produced either without mechanical treatment or with the mechanical treatment. The examples likewise show clearly that the additional process step of mechanical treatment can bring about an improvement in the self-cleaning properties.

1. A process for producing hydrophobic nanostructured surfaces, which comprises applying a dispersion of water in hydrophobic oxides to the surface to be treated and subsequently removing the water from this dispersion.

2. The process as claimed in claim 1, wherein the dispersion used has from 80% by weight to 98% by weight of water.

3. The process as claimed in claim 1, wherein the dispersion is applied to the surface of a textile fabric.

4. The process as claimed in claim 1, wherein the dispersion is applied to the surface of a polymer film.

5. The process as claimed in claim 1, wherein the dispersion used comprises hydrophobic pyrogenic silica as the hydrophobic oxide.

6. The process as claimed in claim 1, wherein the surface to be treated is sprinkled with the dispersion.

7. The process as claimed in claim 1, wherein the surface is treated mechanically after the application of the dispersion.

8. The process as claimed in claim 7, wherein the surface is brushed after the application of the dispersion.

9. The process as claimed in claim 7, wherein the surface is subjected to vibrations and/or shaking motions after the application of the dispersion.

10. The process as claimed in claim 7, wherein the surface is subjected to a mechanical pressure after the application of the dispersion.

11. The process as claimed in claim 1, wherein the water is removed by means of application of a vacuum.

12. The process as claimed in claim 1, wherein the water is removed by means of electromagnetic radiation.

13. The process as claimed in claim 1, wherein the dispersion is separated into water and hydrophobic oxide by means of mechanical pressure.

14. A surface produced by means of a process as claimed in claim 1.

15. The surface as claimed in claim 14, which has soil- and water-repellent properties.

16. A method for producing a soil- and water-repellent surface comprising the process as claimed in claim 1.

17. The method as claimed in claim 16 for producing soil- and water-repellent surfaces of textile fabrics.

18. The method as claimed in claim 16 for producing soil- and water-repellent surfaces of clothing, industrial textiles, fabrics for textile construction, nonwovens and carpets.

19. The method as claimed in claim 16 for producing soil- and water-repellent surfaces of films.
